(19) United States
(12) Patent Application Publication
(10) Pub. No.: US 2003/0045196 A1
(43) Pub. Date: Mar. 6, 2003

(54) Composite nonwoven fabric having high strength and superior printability and fabrication method of the same

(76) Inventor: Hideo Kumehara, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/228,149

(22) Filed: Aug. 26, 2002

(30) Foreign Application Priority Data
Aug. 28, 2001 (JP) 2001-257905

(51) Int. Cl. D04H 1/46; D01D 5/32; D01D 5/34; B32B 31/08

(52) U.S. Cl. 442/402; 264/103; 264/171.1; 264/172.14; 264/172.15; 156/148; 156/164; 156/296; 442/327; 442/361; 442/362; 442/364

(57) ABSTRACT

A composite nonwoven fabric includes a stretched unidirectionally aligned nonwoven fabric in which filaments composed of a thermoplastic resin are unidirectionally aligned and stretched and a dry nonwoven fabric that is provided on one side of the stretched unidirectionally aligned nonwoven fabric and that includes thermal-bonding fibers as a chief component. The filaments of the stretched unidirectionally aligned nonwoven fabric and the dry nonwoven fabric are intertwined by a needlepunch process, following which the two fabrics are unified by a thermal calendering process to produce the composite nonwoven fabric.

### BACKGROUND OF THE INVENTION

1. Field of the Invention

The present invention relates to a composite nonwoven fabric in which a stretched unidirectionally aligned nonwoven fabric and a dry nonwoven fabric are combined, and to a method of fabricating such a composite nonwoven fabric.

2. Description of the Related Art

Nonwoven fabric may be divided between dry nonwoven fabric and wet nonwoven fabric according to the method of fabrication. The production of dry nonwoven fabric has been increasing in recent years due to its productivity and economy. Of the various types of dry nonwoven fabric, spunbonded nonwoven fabric in particular has high productivity and serves for a wide variety of uses, such as for various types of base materials for hygienic and medical uses, household uses, and industrial uses, as well as for agricultural materials. The spunbonded nonwoven fabric is formed by extruding thermoplastic resin from a multiplicity of spinnerets, attenuating the thus-formed filament group of a long continuous fibers through an ejector by air at high speed and high pressure, and then collecting and piling on a support material.

However, the filaments of spunbonded nonwoven fabric have a diameter that typically exceeds 20 μm, and further, have an overall random alignment, and these factors tend to detract from the smoothness of the surface of such a fabric. The fabric therefore lacks printability and does not lend itself to wide use as a packaging material or as a material for home furnishings. In addition, when spunbonded nonwoven fabric is produced with a low basis weight, variations in the thickness of the fabric become extreme, and this characteristic limits the use of such fabric to cheap and simple packaging material when used in the field of packaging materials. Typically, the lowest basis weight for spunbonded nonwoven fabric is 20 g/m². There has been a great desire in the fields of packaging materials and materials for home furnishings for a nonwoven fabric having low basis weight, homogeneous texture, and superior printability.

Japanese Examined Patent Application No. 36948/91 discloses a cross-laminated nonwoven fabric in which two stretched unidirectionally aligned nonwoven fabrics, each having filaments composed of thermoplastic resin that are aligned and stretched in one direction, are laminated in a mutually orthogonal arrangement. The stretched unidirectionally aligned nonwoven fabric is strengthened by stretching the filaments in the direction of alignment. The cross-laminated nonwoven fabric uses stretched unidirectionally aligned nonwoven fabric, and therefore exhibits strong light reflectance that accompanies the alignment of filaments. This nonwoven fabric therefore has an extremely glossy appearance. In addition, regulating the spinning conditions and stretching conditions enables free control of the diameter of the filaments. As a result, when using a nonwoven fabric having low basis weight, the diameter of the filaments can be easily reduced to produce a nonwoven fabric having a homogeneous texture.

In addition, since filaments are aligned in one direction, stretched unidirectionally aligned nonwoven fabric features both low basis weight and high strength. The nonwoven fabric can therefore be realized that has high strength, uniform thickness, even if the basis weight is 20 g/m² or less, which have been difficult to achieve in spunbonded nonwoven fabric.

As described above, a stretched unidirectionally aligned nonwoven fabric inherently possesses excellent characteristics.

However, when stretched unidirectionally aligned nonwoven fabric is laminated to produce a cross-laminated nonwoven fabric, a thermal embossing method is typically used to laminate the mutually orthogonal filaments so as to effectively bond the filaments together. As a result, the surface becomes uneven due to partial fusion bonding between filaments, and this unevenness detracts from both the appeal of the external appearance and the printability. Further, because filaments are aligned in one direction, stretched unidirectionally aligned nonwoven fabric suffers from extreme weakness in the direction that is perpendicular to the direction of alignment of filaments, and stretched unidirectionally aligned nonwoven fabric therefore cannot be used by itself.

### SUMMARY OF THE INVENTION

It is an object of the present invention to provide a composite nonwoven fabric that, while having a low basis weight and homogeneous texture, also has good strength not only in one direction, but in other directions as well, and moreover, has excellent printability, and that can ideally be used for packaging material or as a material for home furnishings, and a method of fabricating this composite nonwoven fabric.

To achieve the above-described objects, the composite nonwoven fabric of the present invention includes: a stretched unidirectionally aligned nonwoven fabric in which filaments composed of a thermoplastic resin are unidirectionally aligned and stretched; and a dry nonwoven fabric that is provided on one surface of the stretched unidirectionally aligned nonwoven fabric, and that has thermal-bonding filaments as a chief component. The filaments of the dry nonwoven fabric are intertwined with those of the unidirectionally aligned nonwoven fabric by means of a needlepunch process, and moreover, the two nonwoven fabrics are unified by a thermal calendering process.

In the method of fabricating the composite nonwoven fabric of the present invention, a stretched unidirectionally aligned nonwoven fabric in which filaments composed of a thermoplastic resin are unidirectionally aligned and stretched, and a dry nonwoven fabric having thermal-bonding filaments as a chief component are first prepared. The stretched unidirectionally aligned nonwoven fabric and dry nonwoven fabric are then laid one on top of the other, and the filaments of each are intertwined by means of a needlepunch process, following which the two fabrics are unified by means of a thermal calendering process.

According to the present invention, the properties of the thermal-bonding filaments of the dry nonwoven fabric are used to unify the stretched unidirectionally aligned nonwoven fabric and the dry nonwoven fabric in the thermal calendering process. As a result, a composite nonwoven fabric is realized that it possesses good strength not only in the direction of alignment of the filaments of the stretched unidirectionally aligned nonwoven fabric, but in other directions as well, while maximizing the characteristics of a stretched unidirectionally aligned nonwoven fabric such as homogeneous texture, glossy feel, and smooth surface at a low basis weight. The composite nonwoven fabric of the present invention therefore has both good strength and exceptional printability, and can be ideally used as a packaging material or as a material for home furnishings. Furthermore, in the composite nonwoven fabric of the present invention, because the stretched unidirectionally aligned nonwoven fabric and dry nonwoven fabric undergo a needlepunch process before undergoing the thermal calendering process, effective fusion bonding can be realized between the stretched unidirectionally aligned nonwoven fabric and the dry nonwoven fabric, and between the filaments of the stretched unidirectionally aligned nonwoven fabric, without loss of the characteristics of the stretched unidirectionally aligned nonwoven fabric.

The basic material of the stretched unidirectionally aligned nonwoven fabric is preferably polyester or polypropylene. In this case, the dry nonwoven fabric is preferably also made from the same basic material as the stretched unidirectionally aligned nonwoven fabric so as to improve adhesion to the stretched unidirectionally aligned nonwoven fabric. In addition, the filaments that make up the dry nonwoven fabric need not be a single structure. For example, when the stretched unidirectionally aligned nonwoven fabric is polyester, the dry nonwoven fabric may be a fabric that is composed of 70-10% by weight of polyester staple filaments and 30-90% by weight of thermal-bonding composite staple filaments comprising a first component composed of polyester and a second component of a polyester-based copolymer having a melting point that is at least 20° C. lower than the melting point of the first component, the thermal-bonding composite staple filaments being obtained by a parallel connected type or a sheath-core type composite spinning.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a sectional view of a composite nonwoven fabric according to an embodiment of the present invention.

FIG. 2 is a schematic structural view of a device for manufacturing the composite nonwoven fabric and is provided for explaining an example of the method of fabricating the composite nonwoven fabric shown in FIG. 1.

### DETAILED DESCRIPTION OF THE PREFERRED EMBODIMENTS

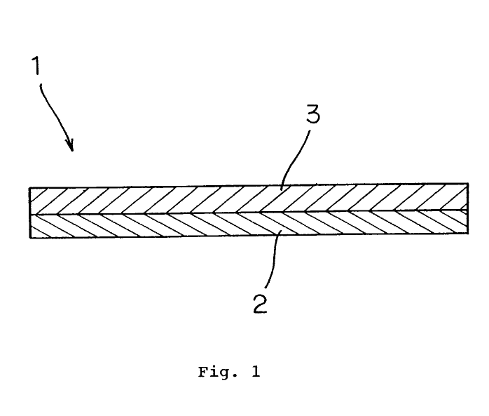

Referring to FIG. 1, there is shown a composite nonwoven fabric 1 according to an embodiment of the present invention. As shown in FIG. 1, composite nonwoven fabric 1 includes: stretched unidirectionally aligned nonwoven fabric 2 in which filaments composed of thermoplastic resin are aligned in substantially one direction and are stretched in the direction of alignment of the filaments; and dry nonwoven fabric 3 that is provided on one surface of stretched unidirectionally aligned nonwoven fabric 2 and that has a thermal-bonding fiber as a chief fiber. Stretched unidirectionally aligned nonwoven fabric 2 and dry nonwoven fabric 3 are combined by means of a needle-punch process, which intertwines the filaments of the two nonwoven fabrics, and a thermal-calendering process, which unifies the two fabrics. FIG. 1 merely shows the overlaid state of stretched unidirectionally aligned nonwoven fabric 2 and dry nonwoven fabric 3, and does not show the state of intertwining of the two fabrics.

Explanation next regards details of stretched unidirectionally aligned nonwoven fabric 2 and dry nonwoven fabric 3.

Stretched Unidirectionally Aligned Nonwoven Fabric

As previously described, stretched unidirectionally aligned nonwoven fabric 2 is a fabric in which filaments are stretched in their direction of alignment, and according to this method, filaments having a fineness (thickness) of 2-3 dTex are spun in a spinning step as with an ordinary nonwoven fabric, but by stretching up to 5-8 times the original length in the direction of alignment of the filaments, the thickness of the filaments is reduced to 1.5 dTex or less. In this case, because the filaments are not yet oriented in the spinning step, and further, because the piled filaments are aligned in a uniform direction, stretching in the direction of alignment of the filaments increases the strength after stretching. However, since the alignment of the filaments in the spinning step is not complete, stretched unidirectionally aligned nonwoven fabric 2 may include some filaments that are not stretched or some filaments that are not oriented, but for the most part, stretched unidirectionally aligned nonwoven fabric is composed of filaments of 1.5 dTex or less. Filaments that are not stretched have a low melting point and thus melt in the subsequent thermal embossing process, and these filaments therefore serve the function of bonding together the filaments of stretched unidirectionally aligned nonwoven fabric 2.

The fineness of the filaments of stretched unidirectionally aligned nonwoven fabric 2 is preferably 0.5 dTex-5 dTex. Filaments that are less than 0.5 dTex are difficult to manufacture, and filaments that exceed 5 dTex detract from the texture and reduce the printability of the resulting nonwoven fabric.

Stretched unidirectionally aligned nonwoven fabric 2 can be divided between longitudinally stretched nonwoven fabric and transversely stretched nonwoven fabric, but either type can be used in the present invention. Longitudinally stretched nonwoven fabric has filaments aligned and stretched in the longitudinal direction, i.e., the direction of conveyance when manufacturing the nonwoven fabric; and transversely stretched nonwoven fabric has filaments aligned and stretched in the transverse direction, i.e., the direction that is perpendicular to the direction of conveyance when manufacturing the nonwoven fabric.

Explanation next regards the details of longitudinally stretched nonwoven fabric and transversely stretched nonwoven fabric.

Longitudinally stretched nonwoven fabric may employ a nonwoven fabric such as the fabric disclosed in Japanese Publication of Unexamined Application No. 204767/98. A longitudinally stretched nonwoven fabric and a method of manufacturing the fabric are next explained hereinbelow.

First, draft tension is applied to filaments that have been extruded from nozzles provided in a die, whereby the filaments are attenuated and piled on a conveyor. At this time, the melted filaments immediately following extrusion from the nozzles are actively heated, or the vicinity of the nozzles (a position immediately after extrusion of filaments from the nozzles) is maintained at a high temperature. At this time, the temperature is kept sufficiently higher than the melting point of the filaments to minimize molecular orientation of the filaments by the draft of the filaments. Means for heating the atmosphere in the vicinity of the nozzles to an elevated temperature include hot air blown from the die, heating by a heater, or a heat insulation tube, and any of these means may be employed. In addition, infrared radiation or laser radiation may also be used as the method of heating the melted filaments.

The use of a melt-blow (MB) die is one method of applying draft tension to the filaments. This method is advantageous in that raising the temperature of the hot blast of air can reduce the molecular orientation of the filaments. In an ordinary MB method, however, the filaments pile randomly on the conveyor and undergo a heat process on the conveyor from the effect of the hot blast of air, and the filaments therefore have low stretchability. In this case, air that contains water in a mist state is directed at an angle with respect to the conveyor surface of the conveyor and onto the filaments that have been spun] from the nozzles, whereby the filaments are aligned in the longitudinal direction and cooled.

As another method of applying a draft tension to the filaments, the spunbonding (SB) method in the narrow sense may be employed. This method employs an ejector or air suction device below a multiplicity of nozzles. The ordinary SB method also brings about molecular orientation of filaments because the filaments are cooled immediately after extrusion from nozzles, and in addition, the filaments are piled randomly on the conveyor. As un the previously described MB method, the filaments can be maintained at an elevated temperature in the vicinity of the nozzles to reduce the molecular orientation, cooling air or water in a mist state can be supplied in the ejector to sufficiently cool the filaments and obtain filaments having good stretchability, and a fluid that contains these filaments can be supplied at an angle to the conveyor surface of the conveyor to improve the alignability of the filaments.

Spinning filaments at an angle with respect to the conveyor surface of the conveyor enables effective alignment of filaments in the longitudinal direction. Effective methods of inclining the filaments with respect to the conveyor surface include tilting the direction of the nozzles with respect to the conveyor, inclining the filament by means of the supplement of a fluid, and inclining the conveyor with respect to the direction of extrusion of the filaments. These methods may be used independently, or some of the methods may be suitably combined. When a fluid is used in the vicinity of the nozzles, the fluid is preferably heated. When not using a fluid in the vicinity of the nozzles, the filaments and the vicinity of the nozzles are actively heated in order to minimize molecular orientation when attenuating the filaments by a draft.

In either of the above-described MB method and SB method, a fluid is used for inclining the filaments with respect to the conveyor surface of the conveyor, and this fluid is most preferably a cool fluid, particularly a fluid containing water in a mist state, in the vicinity of the conveyor. This form is stipulated in order to inhibit crystallization by quenching the extruded filaments. The development of crystallization in the filaments reduces stretchability. In addition, spraying water in a mist state has the additional effect of causing web that has piled on the conveyor to adhere to the conveyor, and this has the effect of improving the spinning stability and the alignability of filaments.

A web is formed by piling filaments on the conveyor as described in the foregoing explanation, and suction of the web from the back surface of the conveyor can not only stabilize web that tends to become unstable due to the inclined motion with respect to the conveyor surface of the conveyor, but can also obtain the effect of eliminating heat. Here, it is crucial that suction of the web be in lines in the direction of width of the conveyor and within a narrow range with respect to the direction of conveyance. Suction is frequently used in an ordinary SB method, but suction in such cases is implemented over an extended area and has the object of increasing the uniformity of the basis weight in the web plane, and moreover, of maximizing the randomness of the alignment of filaments, and therefore has a different object than suction in the present embodiment. Further, suction in the present embodiment also helps to eliminate water that was blown in a mist state for cooling and thus also has the effect of reducing the effect of water in the subsequent stretching step. Water greatly affects the stretchability of polyester. Not only do variations in the amount of water from area to area result in a loss of uniformity in stretching, but the effect of water decreases the degree of stretching as well as the strength of the web after stretching.

The web that has piled on the conveyor is stretched in the longitudinal direction, thereby producing the longitudinally stretched nonwoven fabric. Stretching the web in the longitudinal direction enables a further improvement of alignability in the longitudinal direction of the filaments. The better the alignment of the filaments in the longitudinal direction at this time, the higher the probability that filaments will be substantially stretched when the web is longitudinally stretched, and the greater the strength of the final stretched web. If the alignment of the filaments is poor, stretching of the web only results in extending the spacing of the filaments. Poor filament alignment therefore decreases the probability that filaments will be substantially stretched and prevents sufficient strength from being obtained after stretching.

In longitudinal stretching of the web, all stretching may be performed in a single stage, but a multi-stage stretching method is generally employed. In the multi-stage stretching method, the stretching at the first stage is performed immediately after spinning as preparatory stretching, following which at the second and subsequent stages stretching is performed as the major stretching. Of these, the stretching at the first stage of the multi-stage stretching preferably employs a short-distance stretching method.

Short-distance stretching is a method in which the web is stretched by the difference between surface speeds of two adjacent sets of rollers while maintaining a short stretching distance (the distance from the starting point to the end point of stretching). In short-distance stretching, the stretching distance is preferably 100 mm or less. In particular, when individual filaments have some degree of curvature despite being generally aligned in the longitudinal direction, keeping the stretching distance as short as possible in short-distance stretching is crucial for effectively stretching the individual filaments.

Heat in the short-distance stretching is normally applied by heating the rollers that are used for stretching, and supplementary heat is applied to a specific stretching point by means of a hot blast of air or infrared light. Alternatively, hot water or steam may also be used as the heat source in short-distance stretching.

In multi-stage stretching, on the other hand, stretching at the second and subsequent stages is not limited to short-distance stretching, and various methods used in stretching ordinary web (an aggregate of fibers and filaments in a nonwoven fabric) can be applied. Stretching methods include, for example, roller stretching, hot water stretching, steam stretching, hot plate stretching, and rolling stretching. Short-distance stretching is not necessarily required because each of the filaments has already been lengthened in the longitudinal direction by the stretching at the first stage.

Explanation next regards a transversely stretched nonwoven fabric. The nonwoven fabric that is disclosed in Japanese Examined Patent Publication No. 36948/91 can be used as an example of transversely stretched nonwoven fabric.

When fabricating a transversely stretched nonwoven fabric, a web is first formed in which filaments are aligned in substantially the transverse direction. A web having filaments arranged in substantially the transverse direction can be formed by using air blown from an air jet that is arranged in the vicinity of the spinning nozzles to deflect filaments that are extruded from spinning nozzles in the transverse direction and then allowing the filaments to pile on the conveyor.

To deflect filaments in the transverse direction by means of air blown from the vicinity of the spinning nozzles, the vicinity of the spinning nozzles is provided with: a plurality (normally three to eight) of first air jets for blowing air bowing the circumferential component of a circle the center of which is at each of the spinning nozzles; and further, outside these first air jets, two second air jets arranged such that the streams of air that are blown from these jets run into each other in the direction parallel to the direction of conveyance of web by the conveyor; and then air is blown from these first and second air jets. Filaments that are extruded from the spinning nozzles are caused to rotate in spiral form by the air that is blown from the first air jets. Air that is blown from the second air jets run into each other on the path of the rotating filaments and spreads in the direction perpendicular to the conveyance of the conveyor, i.e., in the transverse direction. The rotating filaments are scattered in the transverse direction by the action of this air, whereby the filaments pile on the conveyor with the majority of the filaments aligned in the transverse direction.

Web thus obtained will be stretched in the transverse direction. The tenter method or pulley method can be adopted as the method of stretching the web in the transverse direction. The tenter method is typically used as a method of spreading materials such as film, and this method requires an extensive area and is not easily adaptable to alterations of the product width or the degree of widening. For nonwoven fabric, the product width must be freely alterable according to the application, and in addition, the degree of stretching must be alterable according to the thickness of the raw materials. The pulley method is therefore preferable because this method allows easy alteration during operation.

A stretching device according to the pulley method includes a pair of pulleys and belts that are arranged with a space between in the direction of width of the web for supporting the edges of both sides of the web. The pulleys are arranged to hold a track that widens forward to the left and right symmetrically with respect to the centerline of the direction of width of the web and rotate at the same surface speed. The belts are rotated under tension in accordance with each pulley, one part of each of these belts fitting into a groove that is formed in the rim of each pulley over a range extending from the position at which the space between the pulleys is narrow to a position at which the space between the pulleys is wide.

The web is introduced at the position where the space between the pulleys is narrow with the edges of both sides of the web held by the pulleys and belts. As the pulleys rotate, the web passes along the forward widening track created by the pair of pulleys while being held between the belts, whereby the web is stretched in the transverse direction. Hot water or a hot gas can be used for heating during this process.

Transversely stretched nonwoven fabric in which the filaments are aligned and stretched in the transverse direction is thus obtained.

The filaments that make up the longitudinally stretched nonwoven fabric and transversely stretched nonwoven fabric are long fiber filaments. Long fiber filaments are essentially long fibers having an average length that exceeds 100 mm. Because the stiffness of filaments having a diameter of 50 μm or more inhibits adequate intertwining, a diameter of 30 μm or less is preferable, and a diameter of 25 μm or less is even more preferable. In particular, when a strong nonwoven fabric is desired, the filament diameter is preferably 5 μm or greater. The length and diameter of the filaments is measured by means of a photomicrograph.

The direction of alignment of the filaments of stretched unidirectionally aligned nonwoven fabric 2 is determined according to the direction in which strength is principally required in composite nonwoven fabric 1. In other words, when composite nonwoven fabric 1 must be strong principally in the longitudinal direction, the direction of alignment of the filaments is in the longitudinal direction, and when strength is required principally in the transverse direction, the direction of alignment of filaments is in the transverse direction.

As previously described, stretched unidirectionally aligned nonwoven fabric 2 has high strength according to the direction of alignment of the filaments, and a nonwoven fabric having a low basis weight can therefore be used. The basis weight of stretched unidirectionally aligned nonwoven fabric 2 is preferably 5-20 g/m². At basis weights of less than 5 g/m², disarray occurs in the alignment of filaments of the surface, and this disarray detracts from the surface smoothness' of composite nonwoven fabric 1 and detracts from printability. On the other hand, a basis weight that exceeds 20 g/m² detracts from the processability when needle-punching with dry nonwoven fabric 3 and consequently raises costs. Sufficient surface smoothness of stretched unidirectionally aligned nonwoven fabric 2 can be achieved at a basis weight of 20 g/m², and the basis weight therefore need not be further increased.

The thermoplastic resin that makes up the filaments of stretched unidirectionally aligned nonwoven fabric 2 may be constituted by, for example, nylon, polyester, or a polyolefin such as high-density polyethylene or polypropylene. Of these, polypropylene and polyester are superior from the standpoints of cost and ease of handling.

Dry Nonwoven Fabric

When stretched unidirectionally aligned nonwoven fabric 2 is of polyester, polyester is also preferably used for dry nonwoven fabric 3 to increase adhesion to stretched unidirectionally aligned nonwoven fabric 2. In this case, dry nonwoven fabric 3 is composed of a polyester staple fiber and a thermal-bonding composite staple fiber in which a first component composed of polyester and a second component composed of a polyester copolymer having a melting point at least 20° C. lower than that of the first component are compositely spun in a parallel connected type or a sheath-core type. The proportion by weight of the thermal-bonding composite staple fiber in dry nonwoven fabric 3 is preferably 30-90%, and the remaining 70-10% is preferably polyester staple fiber. A proportion by weight of the thermal-bonding composite staple fiber of less than 30% is not preferable because adhesion to stretched unidirectionally aligned nonwoven fabric 2 is weak and the peeling strength is low. A proportion by weight of the thermal-bonding composite staple fiber in excess of 90%, on the other hand, causes poor dimensional stability, because the composite nonwoven fabric 1 after the needle-punching process has a strong tendency to extend in the direction of width during fabrication of dry nonwoven fabric 3, and further, is subject to extensive shrinking following the thermal calendering process. Further, when combined with stretched unidirectionally aligned nonwoven fabric 2, composite nonwoven fabric 1 thus obtained is generally stiff, lacking a voluminous property, and not suited for uses as a packaging material or material for home furnishings.

As the polyester copolymer that constitutes the second component, modified polyester obtained by the addition of an amount of isophthalic acid appropriate for producing the objective melting point is preferably used.

When stretched unidirectionally aligned nonwoven fabric 2 is polypropylene, polypropylene is also preferably selected as dry nonwoven fabric 3 to increase adhesive strength. In this case, dry nonwoven fabric 3 is composed of a polypropylene staple fiber and a thermal-bonding composite staple fiber in which a first component composed of polypropylene and a second component composed of an olefin copolymer having propylene as a chief component and having a melting point at least 20° C. lower than that of the first component are compositely spun in a parallel connected type or a sheath-core type. The proportion by weight of the thermal-bonding composite staple fiber in dry nonwoven fabric 3 is preferably 30-90%, and the remaining 70-10% is preferably the polypropylene staple fiber. As previously explained, a proportion by weight of the thermal-bonding composite staple fiber of less than 30% is not preferable because the adhesive strength to stretched unidirectionally aligned nonwoven fabric 2 is weak and the peeling strength is therefore low.

For the olefin copolymer that serves as the second component, suitable candidates include a random copolymer of propylene and ethylene, or a ternary copolymer composed of propylene, ethylene, and butene-1.

The thermal-bonding staple fiber, polyester staple fiber, or polypropylene staple fiber that is used in this embodiment preferably has a fineness of 1-10 dTex and a fiber length of 25-150 mm. When the fineness is less than 1 dTex, fabrication of the web by carding is problematic, and when the fineness exceeds 10 dTex, intertwining of filaments with stretched unidirectionally aligned nonwoven fabric 2 in the needlepunch process is insufficient, resulting in reduction in peeling strength.

As described heretofore, dry nonwoven fabric 3 is used for securing the filaments that make up stretched unidirectionally aligned nonwoven fabric 2 that has an appealing design, a homogeneous texture with low basis weight, glossiness, and an exceptionally smooth surface; and taking advantage of the heat sealability of this dry nonwoven fabric 3, stretched unidirectionally aligned nonwoven fabric 2 and dry nonwoven fabric 3 can be unified by means of a thermal calendering process, whereby composite nonwoven fabric 1 can be obtained that makes the best use of the characteristics of stretched unidirectionally aligned nonwoven fabric 2.

Further, by applying a needlepunch process before carrying out the thermal calendering process of stretched unidirectionally aligned nonwoven fabric 2 and dry nonwoven fabric 3, the filaments of stretched unidirectionally aligned nonwoven fabric 2 and dry nonwoven fabric 3 become intertwined, thereby improving the bonding between stretched unidirectionally aligned nonwoven fabric 2 and dry nonwoven fabric 3 and enabling composite nonwoven fabric 1 to have adequate strength in more than one direction and not only in the direction of alignment of the filaments of stretched unidirectionally aligned nonwoven fabric 2. Finally, by carrying out the needlepunch process, the filaments of stretched unidirectionally aligned nonwoven fabric 2 are also effectively bonded in the subsequent thermal calendering process, whereby fuzz of the filaments is suppressed and the characteristics of stretched unidirectionally aligned nonwoven fabric 2 are not lost.

Composite nonwoven fabric 1 therefore has good strength in more directions than only the direction of alignment of the filaments of stretched unidirectionally aligned nonwoven fabric 2, and moreover, the surface on the side of stretched unidirectionally aligned nonwoven fabric 2 has exceptional printability, and can therefore be ideally used for home furnishing materials such as roll curtains, pleated curtains and wallpaper, as well as for various packaging materials such as bags of all kinds.

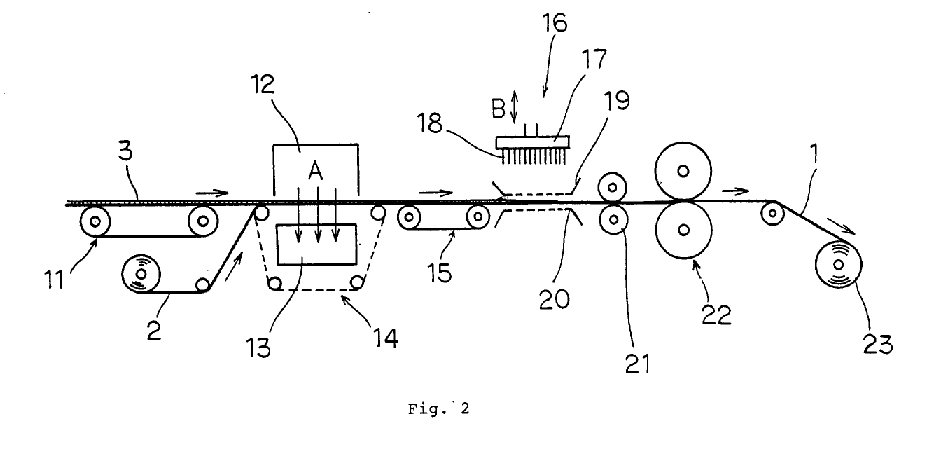

In reference to FIG. 2, an example of the method of fabricating composite nonwoven fabric 1 will be described hereinafter.

Stretched unidirectionally aligned nonwoven fabric 2 is fed out from a feeder and conveyed toward the right of the figure by conveyor 14, which has a mesh form. Dry nonwoven fabric 3 that has been fabricated in a carding machine (not shown) is supplied from conveyor 11 to conveyor 14 such that dry nonwoven fabric 3 is laid on stretched unidirectionally aligned nonwoven fabric 2 and conveyed toward the right of the figure together with stretched unidirectionally aligned nonwoven fabric 2.

Hot-blast air unit 12 is arranged over conveyor 14, and suction unit 13 is arranged below with conveyor 14 interposed. Hot air is blown from hot-blast air unit 12 in the direction of arrow A so as to pass in and out of conveyor 14, whereby stretched unidirectionally aligned nonwoven fabric 2 and dry nonwoven fabric 3 are temporarily bonded on conveyor 14.

After stretched unidirectionally aligned nonwoven fabric 2 and dry nonwoven fabric 3 have been temporarily bonded by hot air, they are conveyed still further by conveyor 15 and supplied to needlepunch unit 16. Needlepunch unit 16 includes: bed plate 20 on which stretched unidirectionally aligned nonwoven fabric 2 and dry nonwoven fabric 3 are placed; needle base unit 17 that is arranged above bed plate 20; and stripper plate 19 that is arranged between bed plate 20 and needle base unit 17. Needle base unit 17 is arranged so that it can move in the direction of thickness (the directions of arrows B) of stretched unidirectionally aligned nonwoven fabric 2 and dry nonwoven fabric 3. In addition, a multiplicity of needles 18 are embedded in the lower surface of needle base unit 17. Needles 18 pass through holes that are formed at positions corresponding to needles 18 in stripper plate 19 and bed plate 20.

Up and down movement of needle base unit 17 causes needles 18 to pierce stretched unidirectionally aligned nonwoven fabric 2 and dry nonwoven fabric 3 that are supplied onto bed plate 20, and the needlepunch process is thus carried out in which the filaments of the two fabrics are intertwined.

After undergoing the needlepunch process, stretched unidirectionally aligned nonwoven fabric 2 and dry nonwoven fabric 3 are further conveyed by conveyor roller 21 and held between a pair of thermal calendering rollers 22. The thermal-bonding fibers in dry nonwoven fabric 3 are melted in the thermal calendering process by means of these thermal calendering rollers 22, unifying stretched unidirectionally aligned nonwoven fabric 2 and dry nonwoven fabric 3 and forming composite nonwoven fabric 1. Composite nonwoven fabric 1 that is continuously formed in this way is rolled up by take-up unit 23.

Dry nonwoven fabric 3 is produced by a carding machine, a parallel web or a cross web being produced depending on variations in the fabrication process. These webs are selected according to the direction of alignment of the filaments of stretched unidirectionally aligned nonwoven fabric 2. More specifically, taking into consideration the balance of strength in the longitudinal and transverse directions of composite nonwoven fabric 1 that is the final product, a cross web is preferably used as dry nonwoven fabric 3 when stretched unidirectionally aligned nonwoven fabric 2 is a longitudinally stretched nonwoven fabric. A cross web is obtained by installing a cloth lapper after the doffer of the roller card of the carding machine and overlaying on the conveyor to obtain filament alignment in the transverse direction. By the same reasoning, a parallel web is preferably used for dry nonwoven fabric 3 when stretched unidirectionally aligned nonwoven fabric 2 is a transversely stretched nonwoven fabric. A parallel web is obtained by stripping the web from the doffer without alteration.

In the example shown in FIG. 2, stretched unidirectionally aligned nonwoven fabric 2 and dry nonwoven fabric 3 are temporarily bonded by hot blast air unit 12 before performing the needlepunch process by needlepunch unit 16, but this temporary bonding process need not necessarily be carried out. However, when temporary bonding is not carried out, difficulty is encountered in conveying stretched unidirectionally aligned nonwoven fabric 2 and dry nonwoven fabric 3 with stability, and the needlepunch process is therefore difficult to perform with uniformity. It is therefore preferable to temporarily bond stretched unidirectionally aligned nonwoven fabric 2 and dry nonwoven fabric 3 before the needlepunch process. When temporarily bonding the fabrics, although the temperature of the hot air depends on the type of low-melting fiber that constitutes the second component of the thermal-bonding fiber used in dry nonwoven fabric 3, the temperature is generally set to 100° C.-200° C.

When carrying out the needlepunch process, needles 18 preferably pass through the dry nonwoven fabric 3 side. If needles 18 would pass through the side of stretched unidirectionally aligned nonwoven fabric 2, it is most likely that the filaments of stretched unidirectionally aligned nonwoven fabric 2 could be conspicuously cut. When the filaments of stretched unidirectionally aligned nonwoven fabric 2 would be cut, the strength of composite nonwoven fabric 1 might be significantly reduced.

The thickness of needles 18 for carrying out the needlepunch process is selected according to the fiber diameter of stretched unidirectionally aligned nonwoven fabric 2 and dry nonwoven fabric 3, but in the present invention, a #30-#40-count blade with an equilateral-triangular cross-section is preferable. The use of a thick blade of less than #30 count results in insufficient intertwining of stretched unidirectionally aligned nonwoven fabric 2 and dry nonwoven fabric 3 and a reduction in the peeling strength. In addition, the needles leave obvious marks in the surface, and these marks reduce the printability and, in particular, detract from appearance when the fabric is used for a packaging material or a home furnishing material. Finally, it should be noted that the state of intertwining between stretched unidirectionally aligned nonwoven fabric 2 and dry nonwoven fabric 3 is further influenced by the shape, number, position, and spacing of the barbs provided on needles 18. Needles 18 that are used in the needlepunch process of stretched unidirectionally aligned nonwoven fabric 2 and dry nonwoven fabric 3 have, for example, 1-9 barbs, an undercut angle of 20-40°, kick-up of 20-40 μm, throat depth of 30-60 μm, a throat length of 1 mm, and a distance of 3 mm from the needle tip to the barbs.

The density of needles 18 when carrying out the needlepunch process is preferably 500/cm² or less. The depth of needles 18 is preferably set to the range of 2-20 mm from the lower surface of stretched unidirectionally aligned nonwoven fabric 2. If the density of needles would exceed 500/cm² or if the depth would exceed 20 mm, there could be a danger of conspicuously cutting the filaments of stretched unidirectionally aligned nonwoven fabric 2 and reducing the strength of composite nonwoven fabric 1. On the other hand, if the depth would be less than 2 mm, intertwining of stretched unidirectionally aligned nonwoven fabric 2 and dry nonwoven fabric 3 could be incomplete and the peeling strength of the two fabrics could be reduced.

The processing temperature in the thermal calendering process is preferably set according to the type of low-melting fibers that constituted the second component of the thermal-bonding fibers are used in dry nonwoven fabric 3, this temperature preferably being set to a temperature equal to or greater than the melting point of the low-melting fiber. At the time of the thermal calendering process, the line pressure that is applied by thermal-calendering rollers 22 is preferably set to approximately 196-588 N/cm.

The actual working examples of the present invention along with an example for comparison will be described below.

### WORKING EXAMPLE 1

The stretched unidirectionally aligned nonwoven fabric was first fabricated as described below. The polyester resin (having an IV value of 0.63 and a melting point of 260° C.) used as a raw material resin was melted and kneaded by an extruder, extruded at a fixed rate by means of a gear pump, and spun in filament form with hot air by a meltblow die. The filaments thus spun were piled on a conveyor and then stretched in the longitudinal direction to six times the original length by means of stretch rollers to obtain a stretched unidirectionally aligned nonwoven fabric (longitudinally stretched nonwoven fabric) in which filaments were aligned in the longitudinal direction. The basis weight of the obtained stretched unidirectionally aligned nonwoven fabric was 10 g/m². The fineness of the filaments was measured by photomicrograph and found to center around 1 dTex.

The dry nonwoven fabric was obtained by mixing a sheath-core type composite staple fiber having a fineness of 1.5 dTex and a fiber length of 50 mm, this composite staple fiber comprising polyester as a first component and a modified polyester (having a melting point of 200° C.) as a second component that contains isophthalic acid, with polyester staple fiber having a fineness of 1.5 dTex and a fiber length of 50 mm, and after jute spreading, passing it through a carding machine and then cloth-lapping. Regarding the proportions by weight of the sheath-core type composite staple fiber and the polyester staple fiber, the dry nonwoven fabric was 70% by weight of sheath-core type composite staple fiber and 30% by weight of polyester staple fiber. The basis weight of the obtained dry nonwoven fabric was 30 g/m².

The stretched unidirectionally aligned nonwoven fabric and dry nonwoven fabric were next temporarily bonded by means of a hot blast air unit at 150° C. and then subjected to a needlepunch process. In the needlepunch process, #36 count, six-barb needles were used. The needle density was 100/cm², and the depth was 10 mm.

The stretched unidirectionally aligned nonwoven fabric and dry nonwoven fabric intertwined by means of the needlepunch process were then unified by means of thermal-calendering rollers heated to 200° C. to obtain a composite nonwoven fabric.

The thus obtained composite nonwoven fabric had a basis weight of 40 g/m², a tensile strength of 150 N/50 mm in the longitudinal direction, and a tensile strength of 120 N/50 mm in the transverse direction. Compared to a typical spunbonded nonwoven fabric, the composite nonwoven fabric had good strength in both the longitudinal and transverse directions, and moreover, the balance of strength in the longitudinal and transverse directions was particularly superior. In addition, clear and distinct printing was achieved when photogravure printing and thermal transfer printing were applied to the stretched unidirectionally aligned nonwoven fabric side of the composite nonwoven fabric, and the printing surface was exceptionally glossy.

### WORKING EXAMPLE 2

The polyester resin (having an IV value of 0.63 and a melting point of 260° C.) used as a raw material resin was melted and kneaded by an extruder, extruded at a fixed rate by means of a gear pump, and then conducted to a spray nozzle. Hot air was blown against the filaments that were spun from the nozzles to scatter the filaments in a direction perpendicular to the direction of movement of the conveyor (i.e., in the transverse direction) to form a web on the conveyor in which filaments were aligned in the transverse direction. This web was next stretched in the transverse direction to 6.5 times the original width by means of a pulley-type transverse stretching device to obtain a stretched unidirectionally aligned nonwoven fabric in which filaments were stretched in the transverse direction (a transversely stretched nonwoven fabric). The stretched unidirectionally aligned nonwoven fabric thus obtained had a basis weight of 10 g/m², and when photographed and measured, the filaments were found to have a fineness that centered around 1 dTex.

As in the first working example, 70% by weight of a sheath-core type composite staple fiber having a fineness of 1.5 dTex and a fiber length of 50 mm and 30% by weight of a polyester staple fiber having a fineness of 1.5 dTex and a fiber length of 50 mm were mixed and then passed through a carding machine to obtain a parallel-aligned dry nonwoven fabric in which fibers were aligned in the longitudinal direction. The dry nonwoven fabric had a basis weight of 30 g/m².

As in the first working example, the stretched unidirectionally aligned nonwoven fabric and the dry nonwoven fabric were next subjected to a needlepunch process and then unified by thermal-calendering rollers to obtain a composite nonwoven fabric.

The composite nonwoven fabric thus obtained had a basis weight of 40 g/m², tensile strength in the longitudinal direction of 100 N/50 mm, and tensile strength in the transverse direction of 130 N/50 mm. In addition, photogravure printing and thermal transfer printing on the stretched unidirectionally aligned nonwoven fabric side of the obtained composite nonwoven fabric showed that clear and distinct printing could be made, and the printed surface was exceptionally glossy.

### COMPARATIVE EXAMPLE 1

A stretched unidirectionally aligned nonwoven fabric and a dry nonwoven fabric were fabricated as in the first working example, and these fabrics were used to fabricate a composite nonwoven fabric in a similar way to the first working example with the exception that a needlepunch process was not performed.

The composite nonwoven fabric thus obtained had a basis weight of 40 g/m², tensile strength in the longitudinal direction of 120 N/50 mm, and tensile strength in the transverse direction of 90 N/50 mm. Since this composite nonwoven fabric did not undergo the needlepunch process, the stretched unidirectionally aligned nonwoven fabric and the dry nonwoven fabric were bonded by the thermal-bonding fibers of the dry nonwoven fabric only at the interface of the two fabrics, and the tensile strengths in the longitudinal and transverse directions were therefore greatly reduced from that of the first working example. In addition, since the bonding of the fibers of the stretched unidirectionally aligned nonwoven fabric was insufficient, fuzz of the fibers was conspicuous, and photogravure printing and thermal transfer printing showed that the printability of the fabric was greatly reduced and that clear or distinct printing could not be made.

Although certain preferred embodiments of the present invention have been shown and described in detail, it should be understood that various changes and modifications may be made without departing from the spirit or scope of the appended claims.

What is claimed is:

1. A composite fabric comprising:
a stretched unidirectionally aligned nonwoven fabric in which filaments that are composed of a thermoplastic resin are unidirectionally aligned and stretched; and
a dry nonwoven fabric comprising thermal-bonding filaments as a chief component and being provided on one surface of said stretched unidirectionally aligned nonwoven fabric, the dry nonwoven fabric having filaments intertwined with filaments of said stretched unidirectionally aligned nonwoven fabric by a needlepunch process, unified with said stretched unidirectionally aligned nonwoven fabric by a thermal calendering processing.

2. A composite nonwoven fabric according to claim 1, wherein:
said stretched unidirectionally aligned nonwoven fabric is composed of polyester; and
said dry nonwoven fabric is composed of 70-10 percent by weight of polyester staple filaments and 30-90 percent by weight of thermal-bonding composite staple filaments comprising a first component of polyester and a second component of a polyester-based copolymer having a melting point that is at least 20° C. lower than the melting point of said first component, said thermal-bonding composite staple filaments being obtained by composite spinning in a parallel connected type or a sheath-core type.

3. A composite nonwoven fabric according to claim 2, wherein:
said needlepunch process is performed with a needle density of 500/cm² or less in such a way that, from the side of said dry nonwoven fabric, the depth of said needles is within the range of 2-20 mm from the lower surface of said stretched unidirectionally aligned nonwoven fabric; and
said thermal calendering process is performed at a temperature in the vicinity of the melting point of the second component of said dry nonwoven fabric.

4. A composite nonwoven fabric according to claim 1, wherein:
said stretched unidirectionally aligned nonwoven fabric is composed of polypropylene; and
said dry nonwoven fabric is composed of 70-10 percent by weight of polypropylene staple filaments and 30-90 percent by weight of thermal-bonding composite staple filaments comprising a first component of polypropylene and a second component of a polypropylene-based copolymer having a melting point that is at least 20° C. lower than the melting point of said first component, said thermal-bonding composite staple filaments being obtained by composite spinning in a parallel connected type or a sheath-core type.

5. A composite nonwoven fabric according to claim 4, wherein:
said needlepunch process is performed with a needle density of 500/cm² or less in such a way that, from the side of said dry nonwoven fabric, the depth of said needles is within the range of 2-20 mm from the lower surface of said stretched unidirectionally aligned nonwoven fabric; and
said thermal calendering process is performed at a temperature in the vicinity of the melting point of the second component of said dry nonwoven fabric.

6. A method of fabricating a composite nonwoven fabric, said method comprising steps of:
preparing a stretched unidirectionally aligned nonwoven fabric in which filaments composed of a thermoplastic resin are unidirectionally aligned and stretched;
preparing a dry nonwoven fabric having thermal-bonding filaments as a chief component;
superposing said stretched unidirectionally aligned nonwoven fabric on said dry nonwoven fabric and intertwining the filaments of the two fabrics by a needlepunch process; and
using a thermal calendering process to unify said stretched unidirectionally aligned nonwoven fabric and said dry nonwoven fabric whose filaments have been intertwined by the needlepunch process.

7. A method of fabricating a composite nonwoven fabric according to claim 6, wherein:
said step of preparing said stretched unidirectionally aligned nonwoven fabric includes producing said stretched unidirectionally aligned nonwoven fabric from polyester; and
said step of preparing said dry nonwoven fabric includes producing said dry nonwoven fabric from 70-10 percent by weight of polyester staple filaments and 30-90 percent by weight of thermal-bonding composite staple filaments comprising a first component of polyester and a second component of a polyester-based copolymer having a melting point that is at least 20° C. lower than the melting point of said first component, said thermal-bonding composite staple filaments being obtained by composite spinning in a parallel connected type or a sheath-core type.

8. A method of fabricating a composite nonwoven fabric according to claim 7, wherein:
said step of intertwining said filaments together includes performing said needlepunch process with a needle density of 500/cm² or less in such a way that, from the side of said dry nonwoven fabric, the depth of said needles is within the range of 2-20 mm from the lower surface of said stretched unidirectionally aligned nonwoven fabric; and
said step of unifying said stretched unidirectionally aligned nonwoven fabric and said dry nonwoven fabric includes performing said thermal calendering process at a temperature in the vicinity of the melting point of the second component of said dry nonwoven fabric.

9. A method of fabricating a composite nonwoven fabric according to claim 6, wherein:
said step of preparing said stretched unidirectionally aligned nonwoven fabric includes producing said stretched unidirectionally aligned nonwoven fabric from polypropylene; and
said step of preparing said dry nonwoven fabric includes producing said dry nonwoven fabric from 70-10 percent by weight of polypropylene staple filaments and 30-90 percent by weight of thermal-bonding composite staple filaments comprising a first component of polypropylene and a second component of a polypropylene-based copolymer having a melting point that is at least 20° C. lower than the melting point of said first component, said thermal-bonding composite staple filaments being obtained by composite spinning in a parallel connected type or a sheath-core type.

10. A method of fabricating a composite nonwoven fabric according to claim 9, wherein:
said step of intertwining said filaments together includes performing said needlepunch process with a needle density of 500/cm² or less such that, from the side of said dry nonwoven fabric, the depth of said needles is within the range of 2-20 mm from the lower surface of said stretched unidirectionally aligned nonwoven fabric; and
said step of unifying said stretched unidirectionally aligned nonwoven fabric and said dry nonwoven fabric includes performing said thermal calendering process at a temperature in the vicinity of the melting point of the second component of said dry nonwoven fabric.
